(19) United States
(12) Patent Application Publication
(10) Pub. No.: US 2009/0109953 A1
(43) Pub. Date: Apr. 30, 2009

(54) ROBUST TIMING SYNCHRONIZATION FOR MB-OFDM FREQUENCY HOPPING SYSTEMS IN A SOP ENVIRONMENT

(75) Inventors: Yui Ming Tsang, Stanford, CA (US); Chi Tin Luk, Hong Kong (CN); Wing Kwan Ng, Hong Kong (CN); Vincent Kin Nang Lau, Hong Kong (CN); Roger Shu Kwan Cheng, Hong Kong (CN); Chi Ying Tsui, Hong Kong (CN)

Correspondence Address: AMIN, TUROCY & CALVIN, LLP, 127 Public Square, 57th Floor, Key Tower, CLEVELAND, OH, 44114, US

(73) Assignee: The Hong Kong University of Science and Technology, Hong Kong (CN)

(21) Appl. No.: 11/926,541

(22) Filed: Oct. 29, 2007

(51) Int. Cl. H04J 3/06

(52) U.S. Cl. 370/350

(57) ABSTRACT

System and methodologies for timing synchronization in a wireless communication system are provided herein. The provided systems and methodologies can utilize various timing synchronization algorithms and an associated state machine to reduce the down time of a wireless communication system due to the presence of simultaneously operating piconets (SOP) and/or other factors. Frequency band finger pattern detection techniques are additionally described that can reduce boundary mismatch rates for wireless receivers. In one example, by making use of the fact that time frequency codes (TFCs) possess unique frequency hopping patterns, system down time can be reduced and OFDM boundary matching can be enhanced to allow a receiver to obtain correct timing information even for communication channels having a very low SINR.

### TECHNICAL FIELD

The present disclosure relates generally to wireless communications systems, and more particularly to techniques for timing synchronization in a wireless communication system.

### BACKGROUND

One of the most important aspects of receiver design in a wireless communication system is timing synchronization, which is aimed at acquiring timing information of a transmitter. Because timing synchronization is often executed without knowledge of exact packet arrival times and channel state information, the accuracy of acquired timing information can be significantly affected by noise and interference present in a communication channel between a receiver and a transmitter. Transmitted information utilized for timing synchronization, such as the preamble of a packet, is therefore required to be specially designed in order to raise the power level of a required signal to make the signal distinguishable.

Conventional timing synchronization can make use of packet preambles in two ways to perform synchronization. First, because the existence of a packet in a channel will raise the energy level of received signals, conventional timing synchronization techniques utilize energy detection for detecting packets. Second, to obtain more precise timing information, a reference sequence that is known to the receiver that has good correlation properties is often added in the preamble of a packet such that multiplying the preamble with the reference sequence yields a signal with a high signal to interference plus noise ratio (SINR).

One technique for wireless communication is Multi-Band OFDM (MB-OFDM), which has been proposed for the IEEE 802.15.3 Wireless Personal Area Network (WPAN) standard for use in Ultra Wideband (UWB) wireless systems. However, MB-OFDM presents differences in physical layer (PHY) design from other techniques for WPAN communication that render conventional timing synchronization techniques less effective in MB-OFDM systems. For example, the PHY structure of MB-OFDM can cause receivers in a WPAN that utilizes MB-OFDM to be sensitive to interference from other receivers in the same WPAN piconet or a neighboring simultaneously operating WPAN piconet. Further, excess interference from aperiodic cross-correlation can be come significant in a system utilizing MB-OFDM when interference is high, which can cause simple mismatch or a higher false alarm rate.

Accordingly, there exists a need for timing synchronization techniques for a wireless communication system that can minimize the effects of interference present in the system.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure provides systems and methodologies for timing synchronization in a wireless communication system. In particular, an algorithm for timing synchronization and a state machine that can be used therewith are provided, which can reduce the down time of a wireless communication system due to factors such as the existence of simultaneously operating piconets (SOP). Further, frequency band finger pattern detection techniques are described herein, which can reduce boundary mismatch rates for wireless receivers even in low-SINR environments.

In one example, the timing synchronization and frequency band finger pattern detection systems and methodologies provided herein can be applied to a Multi-Band OFDM (MB-OFDM) frequency hopping wireless system operating in the presence of simultaneously operating piconets. By making use of the fact that time frequency codes (TFCs) possess unique frequency hopping patterns and other properties of TFCs, system down time can be reduced and OFDM boundary matching can be enhanced to allow a receiver to obtain correct timing information even for communication channels having a very low SINR.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed. The claimed subject matter is intended to include all such aspects and their equivalents. Other advantages and novel features of the claimed subject matter can become apparent from the following detailed description when considered in conjunction with the drawings.

### BRIEF DESCRIPTION OF THE DRAWINGS

FIG. 1 is a high-level block diagram of a wireless communication system operating in the presence of simultaneously operating piconets.

FIG. 2 is a block diagram of an example wireless receiver structure in accordance with various aspects.

FIG. 3 is a state diagram that can be utilized for timing synchronization in a wireless communication system in accordance with various aspects.

FIGS. 4-7 are timing diagrams that illustrate example timing synchronization procedures that can be employed in a wireless communication system in accordance with various aspects.

FIG. 8 is a block diagram of an example finger detection component that can be used for timing synchronization in accordance with various aspects.

FIG. 9 is a flowchart of a method of timing synchronization in a wireless communication system in accordance with various aspects.

FIG. 10 is a flowchart of a method of timing synchronization in a wireless communication system in accordance with various aspects.

FIG. 11 is a flowchart of a method of identifying a time frequency code based on finger detection in accordance with various aspects.

FIG. 12 is a block diagram of an example operating environment in which various aspects described herein can function.

FIG. 13 illustrates an example wireless communication network in which various aspects described herein can be utilized.

FIG. 14 illustrates an overview of a wireless network environment suitable for service by various aspects described herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g., data from one component interacting with another component in a local system, distributed system, and/or across a network such as the Internet with other systems via the signal).

Additionally, while the present disclosure generally relates to an UWB wireless communication system utilizing MB-OFDM, those skilled in the art will recognize that the claimed subject matter can be used and applied in any wireless communication system that requires timing synchronization. It is to be appreciated that the systems and/or methods described herein can be employed in any suitable wireless communication system and that all such systems are intended to fall within the scope of the hereto appended claims.

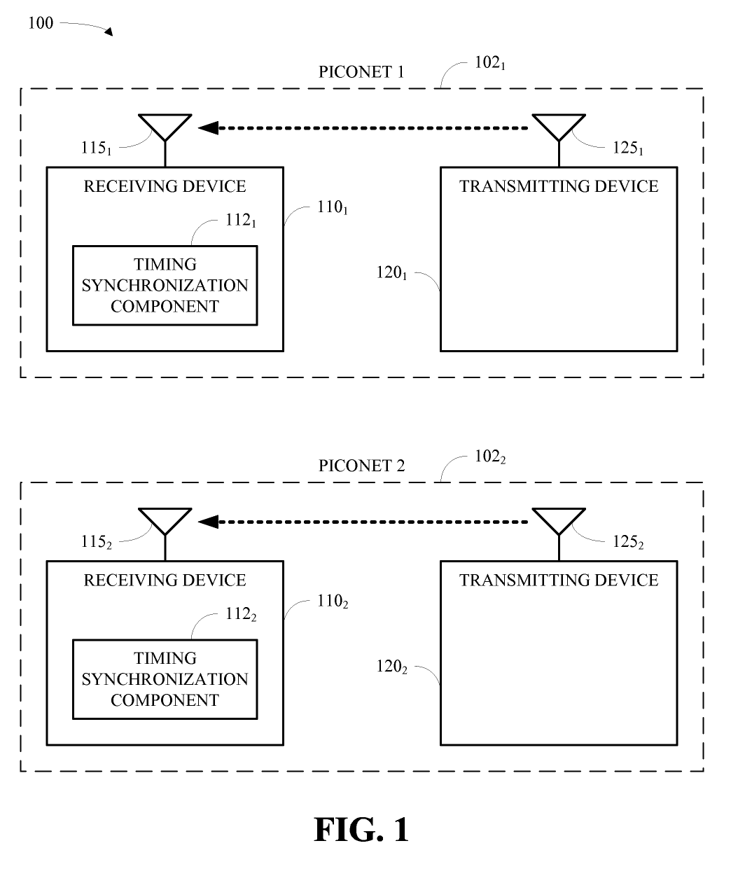

Referring to FIG. 1, a high-level block diagram of a wireless communication system 100 operating in the presence of simultaneously operating piconets 102 is illustrated. In accordance with one aspect, each piconet 102 can support one or more wireless personal area networks (WPANs) and/or other suitable wireless communication networks. Each network supported by the piconets 102 can include any number of devices 110 and/or 120 that can communicate using respective antennas 115 and 125. While two piconets 102 are illustrated in system 100, it should be appreciated that system 100 can include any number of piconets 102.

In one example, a transmitting device 120 in a piconet 102 can transmit data and/or control signaling to a receiving device 110 in the piconet 102. While devices 110 are labeled as receiving devices and devices 120 are labeled as transmitting devices in system 100, it should be appreciated that a device 110 and/or 120 in a piconet 102 can be capable of both receiving and transmitting at one or more time intervals. For example, while not illustrated in system 100, a receiving device 110 in a piconet 102 can additionally transmit data and/or control signaling to a transmitting device in the piconet 102 at a common time interval as a transmission from the transmitting device 120 to the receiving device 110 or at a different time interval.

In another example, a receiving device 110 can enter and initiate communication with one or more other devices within a piconet 102 by receiving beacons and/or other control signaling from a transmitting device 120 in the piconet. This signaling can be used, for example, to allow the receiving device 110 to synchronize with other devices in the piconet 102. In accordance with one aspect, to aid a receiving device 110 in synchronizing within a piconet 102, the receiving device 110 can include a timing synchronization component 112. The timing synchronization component 112 can receive synchronization signals from a transmitting device 120 in the piconet 102 and use these signals to obtain information regarding system timing and frequency bands used for transmission by devices in the piconet 102. For example, in a frequency hopped MB-OFDM system, a timing synchronization component 112 can obtain information relating to a time frequency code (TFC) used in a piconet 102 to facilitate synchronization of an associated receiving device 110 with timing and/or frequency band patterns provided by the TFC.

In accordance with another aspect, a timing synchronization component 112 can be robustly designed to provide resilience to interference caused by other devices in a piconet 102 associated with a receiving device 110 and/or other simultaneously operating piconets 102 in system 100. Conventional timing synchronization techniques typically make use of a reference sequence that is embedded in the preamble of a packet and known to a receiving device. This is often accomplished through techniques such as autocorrelation of received preambles and cross-correlation between received preambles and a known reference sequence. The former technique, also known as packet detection, is used to detect the arrival of a packet by checking for a rising energy level associated with packet arrival. The latter technique, also known as symbol timing, is typically used to refine rough timing information provided by packet detection by cross-correlating a received packet with a reference signal with good auto-correlation properties to obtain more precise symbol boundaries. However, due to difference in physical layer (PHY) design between Ultra Wideband (UWB) systems utilizing MB-OFDM and conventional wireless communication systems, the presence of simultaneously operating piconets (SOP) in a wireless communication system, and/or other factors, these conventional timing synchronization techniques can result in reduced system efficiency, reduced tolerance to interference, and increased system down time. For example, wireless communication systems that do not provide collision avoidance measures, such as a carrier sense multiple access with collision avoidance (CSMA/CA) mechanism, may experience a greater amount of interference between devices in a piconet. In addition, excess interference experienced in a wireless communication system due to aperiodic cross-correlation can become significant when the SINR of the system is high, which can cause sample mismatch and/or high false alarm rates. Further, the presence of SOP can render simple changes to detection threshold values insufficient to accommodate a tradeoff among miss detection rates, false alarm rates, and sample mismatch rates in a wireless communication system.

Accordingly, a timing synchronization component 112 can utilize one or more robust timing synchronization techniques as well as an improved state transition scheme as described in more detail infra to reduce the down time of system 100 due to the existence of simultaneously operating piconets 102. In one example, by making use of the fact that time frequency codes possess unique frequency hopping patterns, a frequency band finger pattern detection method, as described in more detail infra, can also be utilized by the timing synchronization component 112 to further reduce system down time and improve symbol boundary matching. Thus, devices in system 100 can obtain correct timing information even in very low SINR environments.

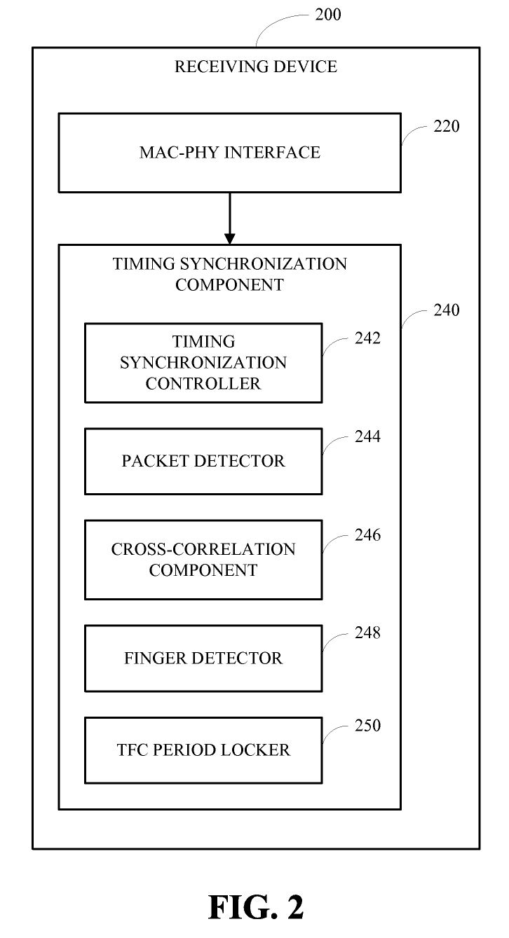

Referring now to FIG. 2, a block diagram of an example wireless receiver structure 200 in accordance with various aspects set forth herein is illustrated. It should be appreciated that the receiving device 200 illustrated in FIG. 2 can be used to communicate with one or more devices (e.g., transmitting device 120) in a WPAN piconet (e.g., a piconet 102) and/or another suitable wireless communication systems or portions thereof.

In accordance with one aspect, the receiving device 200 can include a timing synchronization component 240 that can employ one or more robust timing synchronization algorithms as described in more detail infra to enhance synchronization performance and reduce down time experienced by the receiving device 200 due to the existence of simultaneously operating piconets, interference between devices in a common piconet, and/or other factors. In one example, the receiving device 200 can include a MAC-PHY interface 220. The MAC-PHY interface 220 can act as a bridge between a physical layer (PHY) and a medium access control layer (MAC) by, for example, facilitating the use of beacons and/or other signaling received from a piconet coordinator device and/or another suitable source in a wireless communication network by components at the receiving device 200 such as the timing synchronization component 240.

In accordance with another aspect, the timing synchronization component 240 can include various subcomponents that can carry out timing synchronization based on signals provided by the MAC-PHY interface 220 and/or another suitable source. By way of example, the timing synchronization component 240 can include a timing synchronization controller 242, which can direct operation of other subcomponents in the timing synchronization component 240. The timing synchronization component 240 can also include a packet detector 244 that can perform packet detection by, for example, autocorrelating successive signals received on one or more given frequency bands.

The timing synchronization component 240 can also include a cross-correlation component 246 and a finger detector 248, which can receive and further process signals for which packet detection has been performed by the packet detector 244. The cross-correlation component 246 and finger detector 248 can process signals for which packet detection has been performed by, for example, determining one or more time frequency code boundaries corresponding to the signals. In accordance with one aspect, to provide resilience against the effects of simultaneously operating piconets, interference, and other aspects of a wireless communication system in which the receiving device 200 resides, the packet detector 244, cross-correlation component 246, and finger detector 248 can work simultaneously to allow the packet detector 244 to continue packet detection for successive signals after packet detection has completed for an initial signal. Further, the timing synchronization component 240 can include a time frequency code (TFC) period locker, which can attempt to lock the receiving device 200 into the period of a TFC obtained by the cross-correlation component 246 and the finger detector 248 to allow the receiving device 200 to utilize the timing of the obtained TFC.

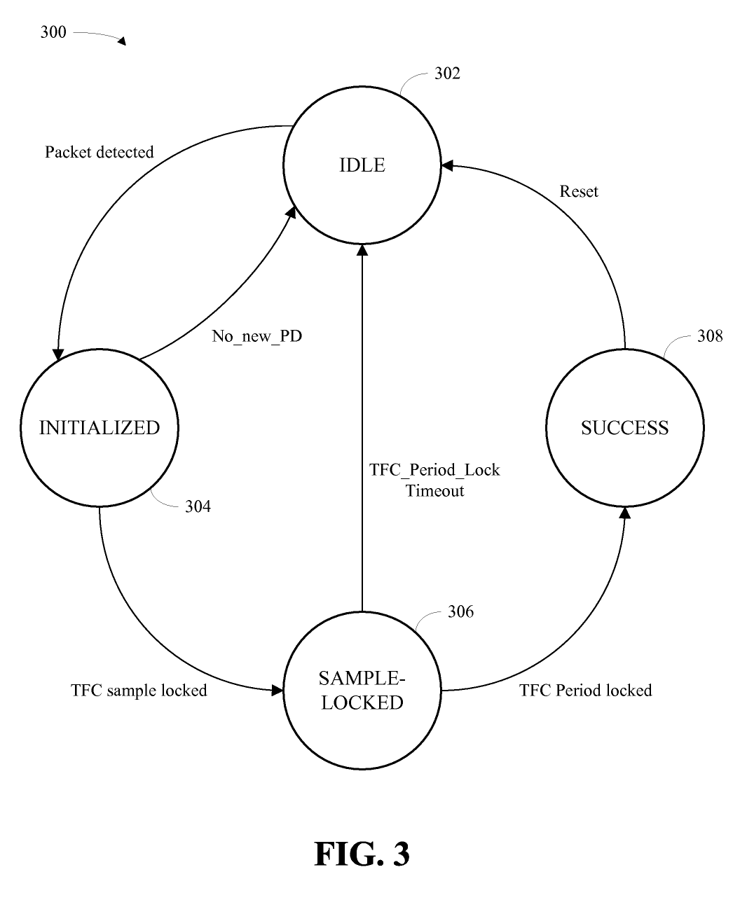

Turning to FIG. 3, a state diagram 300 that can be utilized for timing synchronization in a wireless communication system in accordance with various aspects is illustrated. In accordance with one aspect, state diagram 300 represents a state machine that can be implemented by a device (e.g., a receiving device 110 using a timing synchronization component 112) in a WPAN piconet and/or another appropriate wireless communication network or portion thereof to execute a timing synchronization algorithm. As illustrated by FIG. 3, state diagram 300 contains 4 states—an idle state 302, an initialized sate 304, a sample-locked state 306, and a success state 308.

In one example, a device employing a state machine represented by state diagram 300 can begin at the idle state 302. In the idle state 302, a device utilizing state diagram 300 can attempt to detect a packet on a predefined band number. When a packet is detected, the device can transition into the initialized state 304 from the idle state 302. At the initialized state 304, cross-correlation and finger detection can be performed in order to lock on to sample boundary of a TFC associated with the detected packet. If the sample boundary of the TFC is successfully locked, a device utilizing state diagram 300 can enter the sample-locked state 306. In one example, a device utilizing state diagram 300 can additionally attempt to detect additional packets at the initialized state 304. If no additional packets are detected within a predetermined period of time, the device can re-enter the idle state 302 from the initialized state 304 to restart the process illustrated by the state diagram 300.

Once a device employing the state diagram 300 reaches the sample-locked state by locking into the sample boundary of a TFC, the device can then attempt to further lock into the period of the TFC to obtain more precise timing information. In the event that the TFC period cannot be successfully locked in a predetermined period of time, a TFC period lock timeout can be declared and a device employing state diagram 300 can return to the idle state 302 to restart the process illustrated by state diagram 300. Otherwise, if the TFC period is successfully locked, a device utilizing state diagram 300 can enter a success state 308, at which time the device has successfully completed timing synchronization. Once the device reaches the success state 308, it can remain at the success state 308 until the device is reset, moved to another network, or otherwise caused to re-execute timing synchronization. Upon such an event, the device can return to the idle state 302 to repeat the process illustrated by state diagram 300.

In accordance with one aspect, by utilizing the state diagram 300 a device can reduce down time caused by false alarm. Unlike conventional state machine design, packet detection pursuant to state diagram 300 can continue attempting to detect new packets even if a packet was detected in the previous sample instant since the previously detected packet may have been produced by interference. By taking this interference into account, the down time of an associated device can be reduced.

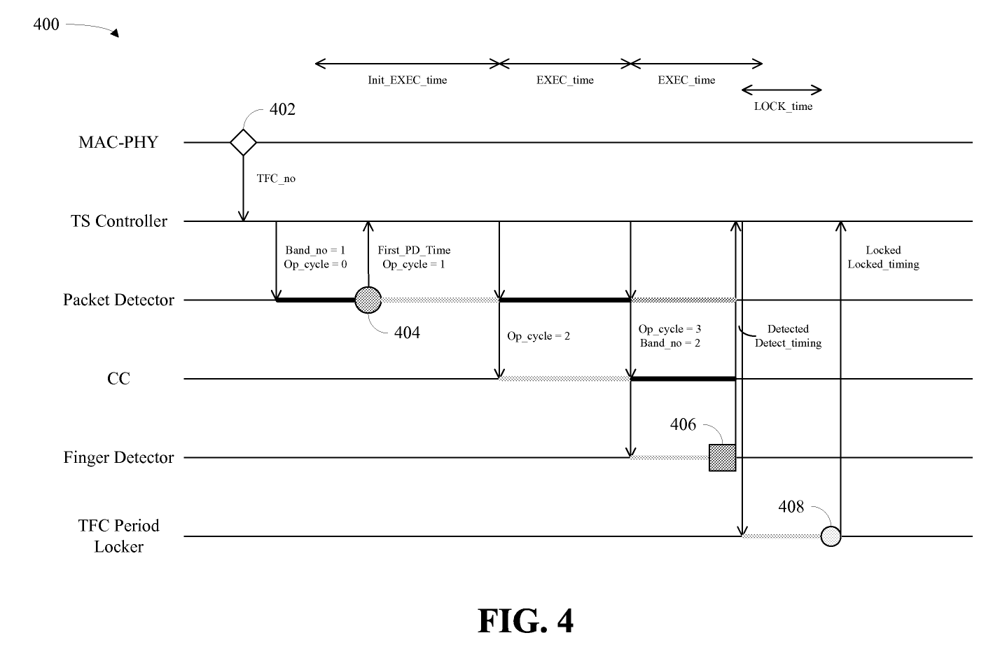

Turning to FIGS. 4-7, timing diagrams 400, 500, 600, and 700 are provided that illustrate various aspects of the timing synchronization procedure represented by state diagram 300. In one example, the timing synchronization processes discussed herein can be implemented using, for example, a MAC-PHY interface (e.g., MAC-PHY interface 220) and a timing synchronization component (e.g., timing synchronization component 240) at a receiving device (e.g., receiving device 200) in a wireless communication system. It should be appreciated, however, that the timing diagrams 400-700 illustrate only one receiver configuration that could be used to implement the timing synchronization procedure represented by state diagram 300 and that said procedure can be performed by any appropriate receiving device having any suitable configuration.

Referring now specifically to FIG. 4, a timing diagram 400 is provided that illustrates a successful timing synchronization without any failed events. As illustrated by FIG. 4, the process illustrated by timing diagram 400 begins when signaling is received from the MAC layer requesting packet reception at event 402. The request provided at event 402 can specify a desired TFC number to a timing synchronization controller (e.g., a timing synchronization controller 242 at a timing synchronization component 240). Based on this request, the timing synchronization controller can then reset all relevant parameters and instruct a packet detector (e.g., a packet detector 244) to start processing on a predefined band number. When a packet is detected, as illustrated at event 404, a device performing the process illustrated by timing diagram 400 can enter an initialized state (e.g., initialized state 304). In this initialized state, a rough timing estimate can be acquired with an uncertainty of a predetermined number of samples (e.g., 165 samples). At event 404, an operating cycle counter is additionally initialized to a count of 1.

After the time marked as Init_EXEC_time on timing diagram 400, where Init_EXEC_time is the time duration of the initial operating cycle, the operating cycle is incremented. Once the operating cycle is incremented, cross-correlation (CC) is initiated (e.g., by a cross-correlation component 246) for the packet detected at event 404 to obtain symbol boundaries for the packet. In the meantime, the packet detector can continue attempting to detect any new packets. If cross correlation is successful after a period of EXEC_time, finger detection can be initiated (e.g., by a finger detection component 248) for the packet. During finger detection, a TFC associated with the packet can be determined, for example, by attempting to lock in to the OFDM symbol boundaries of the packet. Further, the operating cycle can be incremented and the band number can be changed. If finger detection successfully completes by locking into the TFC sample boundaries associated with the packet, as illustrated at event 406, a device performing the process illustrated by timing diagram 400 can enter a sample-locked state (e.g., sample-locked state 306). Once a sample-locked state has been entered, the operating cycle counter can stop counting and a TFC period detector (e.g., a TFC period locker 250) can detect the period of the TFC associated with the packet. If the period of the associated TFC is successfully locked, as illustrated at event 408, the timing synchronization process illustrated by timing diagram 400 can complete and a device utilizing said process can communicate using the timing information provided by the obtained TFC.

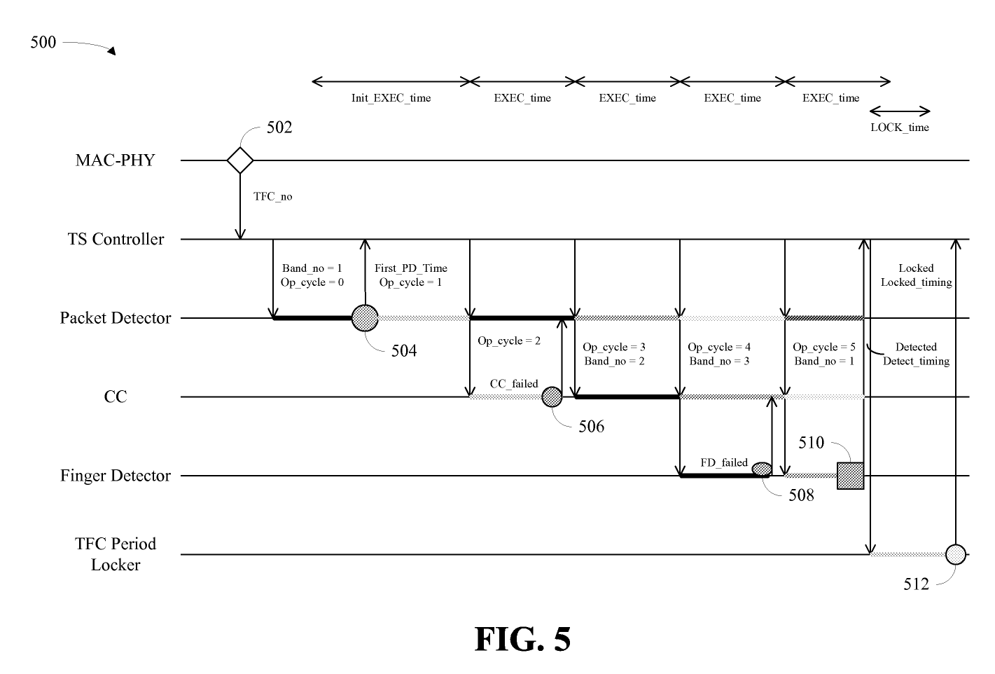

Turning to FIG. 5, a timing diagram 500 is provided that illustrates a successful timing synchronization with failed events in the initialized state (e.g., initialized state 304). The timing synchronization process illustrated by timing diagram 500 can start at event 502 by receiving signaling from the MAC layer specifying a desired TFC number and at event 504 by detecting a packet in a similar manner to events 402 and 404 in timing diagram 400. However, unlike timing diagram 400, cross-correlation may fail to successfully complete, as illustrated at event 506. As illustrated by timing diagram 500, the finger detector can remain idle in response to a failed cross-correlation and instead wait for a following packet to be detected. Further, if finger detection fails to complete for a packet, as illustrated by event 508, TFC period detection can similarly remain idle and wait for a following packet. Once finger detection is successfully performed for a packet, as illustrated by event 510, TFC period detection can proceed in a similar manner to the finger detection described relative to timing diagram 400 as illustrated at event 512.

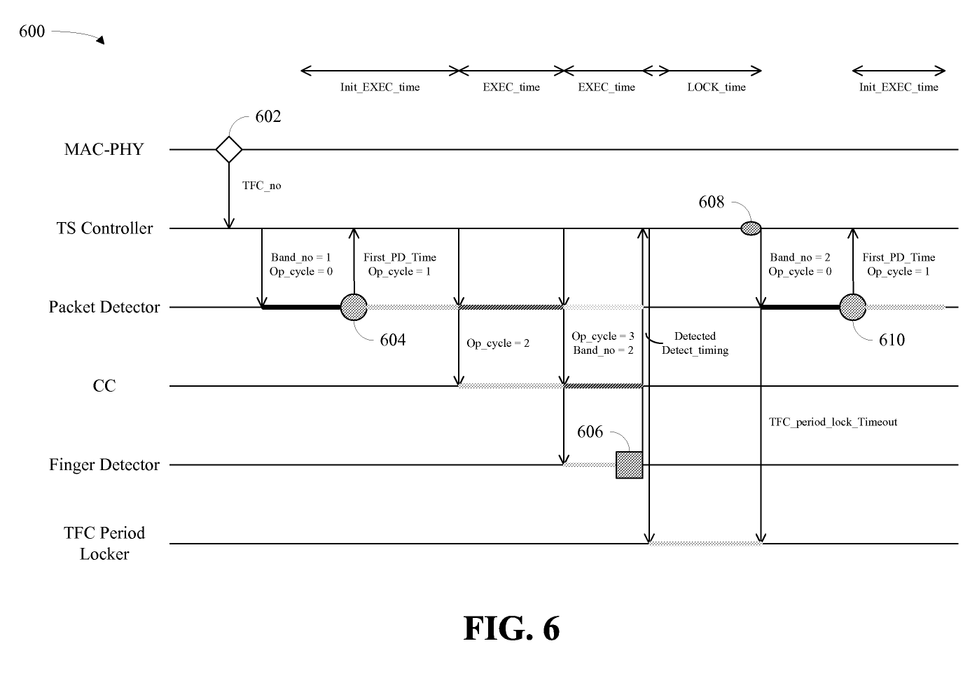

Referring to FIG. 6, a timing diagram 600 is provided that illustrates unsuccessful timing synchronization due to TFC locking failure. As illustrated by timing diagram 600, an initial request with a desired TFC number can be received at event 602 in a similar manner to event 402 in timing diagram 400, and successful packet detection and finger detection can subsequently be performed for a packet at respective events 604 and 606 in a similar manner to events 404 and 406 in timing diagram 400. After successful finger detection, a TFC period detector can detect the period of a TFC associated with the packet. However, if finger detection successfully completes for a packet but the TFC period detector fails to lock on to the correct TFC period boundary within a predetermined period of time, as illustrated at event 608, the timing synchronization process can restart with the detection of a new packet on a new frequency band as illustrated at event 610.

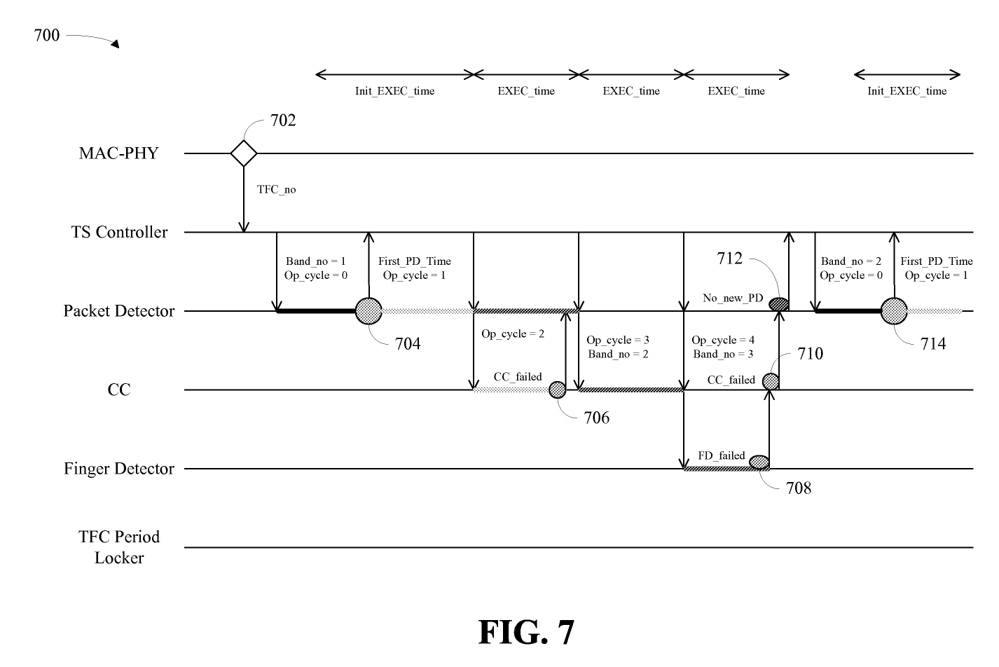

Referring now to FIG. 7, a timing diagram 700 is provided that illustrates unsuccessful timing synchronization due to packet detection failure. The process illustrated by timing diagram can begin with an initial request with a desired TFC number at event 702 and initial packet detection at event 704 in a similar manner to events 402 and 404 illustrated by timing diagram 400. Cross-correlation may then fail for a detected packet as illustrated at event 706 in a similar manner to event 506 in timing diagram 500, at which point the finger detector can remain idle and wait for a subsequent packet. In addition, finger detection may fail for a packet as illustrated at event 708 in a similar manner to event 508 in timing diagram 500, at which point the TFC period detector can also remain idle and wait for a subsequent packet.

If the packet detector fails to detect a packet during an operation cycle, as illustrated in timing diagram 700 at operation cycle 3, cross-correlation can fail in the following operation cycle due to the lack of a packet for cross-correlation as illustrated at event 710. A cross-correlation component can then provide notice of its failure to the packet detector and wait for a subsequent packet. However, if the packet detector again fails to detect a packet during an operation cycle in which a notification of cross-correlation failure is received, the packet detector can notify the timing synchronization controller than no packet has been detected as illustrated at event 712. In response to this notification, the timing synchronization process can restart with the detection of a new packet on a new frequency band as illustrated at event 714.

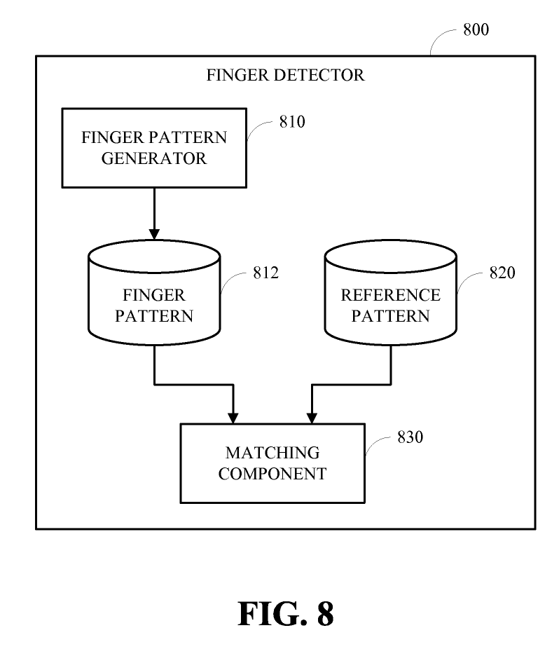

Referring to FIG. 8, a block diagram of an example finger detection component 800 that can be used for timing synchronization in accordance with various aspects is provided. By way of specific example, finger detector 800 can be utilized by a receiving device (e.g., a receiving device 200) operating in a MB-OFDM system based on standards proposed by the Multi-Band OFDM Alliance (MBOA) and/or other appropriate system standards. Further, the finger detector 800 can be used in conjunction with a timing synchronization component (e.g., a timing synchronization component 240) at the receiving device. In one example, by using the finger detector 800 for timing synchronization, symbol boundary mismatches can be reduced in high-interference environments. In accordance with one aspect, physical channels in a system utilizing MBOA standards can hop in different frequency bands periodically according to a TFC. By way of specific, non-limiting example, a hopping pattern provided by a TFC can specify time-frequency interleaving (TFI), where information is interleaved over three frequency bands for transmission, or fixed-frequency interleaving (FFI), where information is transmitted on a single band. In another example, a system employing finger detector 800 can utilize one of seven TFCs, each of which specifies a unique hopping pattern.

In accordance with one aspect, a device associated with the finger detector 800 can receive a collection of fingers in each frequency band utilized by the system in which the device communicates. These fingers can be received and/or processed by a finger pattern generator 810 at the finger detector 800. In one example, fingers occur in periodic patterns every TFC period regardless of noise present in the system. Accordingly, the finger pattern generator 810 can produce a finger pattern 812, herein defined as a Frequency Band Finger Pattern (FBFP), Ψ. In one example, a finger pattern 812 can be generated as a matrix of size N×(T×L), where N represents the number of frequency bands utilized by the system (e.g., 3), T represents the period of a TFC in OFDM symbols (e.g., 6), and L represents a number of samples per OFDM symbol (e.g., 165). In one example, the FBFP can specify fingers identified in different bands within a TFC period such that Ψ(n, l) is a signal received at band N at sample timing L.

If a channel utilized by the finger detector 800 is noiseless and free of inter-symbol interference (ISI), the finger pattern 812 generated by the finger pattern generator 810 can contain peak values at sample timings for which a reference base sequence and received preambles are aligned and smaller values at other sample timings due to aperiodic auto-correlations. Therefore, if a reference base sequence and a received preamble are aligned at sample timing 0<p≦165 and an i-th TFC is used, a corresponding finger pattern 812 can be written as follows:

$${Ψ}_{noiselessISI \text{-} free} ( ( n , l ) \vert ( i , p ) ) = \{ \begin{matrix}{\sum }_{m} {\vert {γ}^{( i )} \{ m \} \vert}^{2} & if ( n , l ) = ( {ϕ}^{( i )} \{ k \} , ( 165 ( k - 1 ) + p ) ) \\ {\sum }_{m} {γ}^{( i )} \{ m \} {γ}^{( i )} \{ m + {( l )}_{165} - p \} & otherwise ,\end{matrix} \qquad ( 1 )$$

where φ⁽ⁱ⁾ is a TFC Band hopping sequence of the i-th TFC, φ⁽ⁱ⁾ {k} is a Band ID of the k-th element of the i-th TFC, γ⁽ⁱ⁾ is the reference base sequence of the i-th TFC padded with zeros for aperiodic cross-correlation, and (.)_{N} is a circular operation with period N.

In accordance with another aspect, a reference pattern 820 can also be utilized by the finger detector 800 for finger detection. In one example, the reference pattern 820, herein denoted as Φ⁽ⁱ⁾, can be defined as a Reference Frequency Band Finger Pattern (R-FBFP) of an i-th TFC. The R-FBFP can have a size of N×T when p=1 and can be constructed as follows:

$$\begin{matrix}{Φ}^{( i )} ( n , s \vert p ) {\vert}_{p = 1} = {Ψ}_{noiseless , ISI \text{-} free} ( ( m , 165 ( s - 1 ) + p \vert ( i , p ) ) \vert p = 1 ) \\ > Cross \text{-} Corrleation threshold .\end{matrix} \qquad ( 2 )$$

In one example, if fingers in Φ⁽ⁱ⁾|ₚ₌₁ have values larger than the cross-correlation threshold, Φ⁽ⁱ⁾|ₚ₌₁ can be represented by the band-hopping sequence of the i-th TFC, φ⁽ⁱ⁾, such that

$$\begin{matrix}{Φ}^{( i )} {\vert}_{p = 1} ⇔ {φ}^{( i )} \\ where , for s = 1 , … , 6 , & ( 3 ) \\ {{φ}^{( i )} \{ s \} = n if {Φ}^{( i )} ( n , s \vert p ) \vert}_{p = 1} \\ and & ( 4 ) \\ {{Φ}^{( i )} ( n , s \vert p ) \vert}_{p = 1} = {\sum }_{m} {\vert {γ}_{m}^{( i )} \vert}^{2} * \{ \begin{matrix}1 & {φ}^{( i )} \{ s \} = n \\ 0 & otherwise .\end{matrix} & ( 5 )\end{matrix}$$

Further, assuming an additive white Gaussian noise (AWGN) channel model, a cross-correlation sample value can be represented as follows:

$$Ψ ( n , l ) \vert {Φ}^{( i )} ( n , s \vert p ) = \{ \begin{matrix}{\sum }_{m} {\vert {γ}_{m}^{( i )} \vert}^{2} + Z & if ( n , l ) = ( {φ}^{( i )} \{ s \} , ( 165 ( s - 1 ) + p ) ) \\ ɛ ( p ) + Z & otherwise ,\end{matrix} \qquad ( 6 )$$

where Z˜N(0,N₀), s=floor (l/165), and ε(p) is due to aperiodic cross-correlation and can be known a priori by the finger detector 800.

In one example, the finger detector 800 can operate in a wireless communication system utilizing MBOA standards on a multipath fading channel. As a result, channel realizations may not be known a priori by the finger detector 800. Further, the best maximum likelihood estimation may not be practical to obtain due to high required complexity. Accordingly, the finger detector 800 can perform a lower complexity symbol timing algorithm as follows. First, for each signal received at an l-th sample instant and an n-th band, the finger pattern generator 810 can declare a finger at instant l and band n in finger pattern 812 if its corresponding Ψ(n, l) value is above a predetermined threshold.

Next, a matching component 830 can be employed to match the sample positions of the fingers in a period in finger pattern 812 with a reference pattern 820. In one example, the reference pattern 820 can be R-FBFP as set forth supra. If a subset of received fingers matches the reference pattern 820 with sample shift p, the finger detector 800 can declare an OFDM boundary at sample instant p at the current band. Alternatively, instead of using a full period of R-FBFP as the reference pattern 820 for the matching process performed by the matching component 830, a limited number of fingers in R-FBFP can be sufficient to determine symbol timing. Accordingly, a Reduced R-FBFP (RR-FBFP) can alternatively be utilized as the reference pattern 820 for matching, such that the first set of fingers in the finger pattern 812 that matches the RR-FBFP can be chosen by the matching component 830. Reference patterns 820 that can be utilized for finger detection are provided below in Tables 1 and 2. Table 1 represents an R-FBFP, and Table 2 represents a RR-FBFP. As illustrated in Table 2, a value of “X” represents a “Don't Care” band at which matching is not performed by the matching component 830.

TABLE 1
Reference Frequency Band Finger Pattern (R-FBFP).

Band No.

| TFC | 1 | 2 | 3 | 4 | 5 | 6 |
|---|---|---|---|---|---|---|
| 1 | 1 | 2 | 3 | 1 | 2 | 3 |
| 2 | 1 | 3 | 2 | 1 | 3 | 2 |
| 3 | 1 | 1 | 2 | 2 | 3 | 3 |
| 4 | 1 | 1 | 3 | 3 | 2 | 2 |
| 5 | 1 | 1 | 1 | 1 | 1 | 1 |
| 6 | 2 | 2 | 2 | 2 | 2 | 2 |
| 7 | 3 | 3 | 3 | 3 | 3 | 3 |

TABLE 2
Reduced Reference Frequency Band Finger Pattern (RR-FBFP).

Band No.

| TFC | 1 | 2 | 3 | 4 | 5 | 6 |
|---|---|---|---|---|---|---|
| 1 | 1 | 2 | X | X | 2 | X |
| 2 | 1 | 3 | X | X | 3 | X |
| 3 | 1 | X | 2 | 2 | X | X |
| 4 | 1 | X | 3 | 3 | X | X |
| 5 | 1 | X | 1 | X | X | X |
| 6 | 2 | X | 2 | X | X | X |
| 7 | 3 | X | 3 | X | X | X |

In accordance with one aspect, finger detector 800 can operate cooperatively with other components of a timing synchronization system (e.g., a timing synchronization component 240) to conduct timing synchronization as follows. First, given that TFC 1 is the desired TFC, packet detection can be carried out (e.g., by a packet detector 244) to determine the existence of a packet. If a packet is detected, cross-correlation can then be performed (e.g., by a cross-correlation component 246) between received samples and a reference base sequence of TFC 1 for 6 OFDM symbols at band φ⁽¹⁾(1). If samples are present that have cross-correlation values above a predetermined threshold, their sample timing indices can be recorded by the finger detection component 800 in a finger pattern 812. Next, the timing synchronization can switch to band φ⁽¹⁾(2), where expected fingers are known based on the recorded sample timing indices. Cross-correlation can then again be performed at the expected sample timing indices in band φ⁽¹⁾(2). If the cross-correlated value of a finger is below the predetermined threshold, which can be denoted as Th_{cc}, the corresponding finger index in the finger pattern 812 can be removed. Finally, the finger pattern 812 can be compared to a reference pattern 820 such as R-FBFP by a matching component 830. Once a sample timing index is found in which three fingers are subsets of the reference pattern 820 of TFC 1, the OFDM boundary for symbol timing has been obtained. In accordance with one aspect, this process can be completed within 14 OFDM symbols in time. Further, the systems and techniques described supra can effectively perform timing synchronization even in high-interference environments. For example, it can be shown that various aspects set forth herein can yield reasonably good performance even when the SINR of an associated wireless communication system approaches −6 dB.

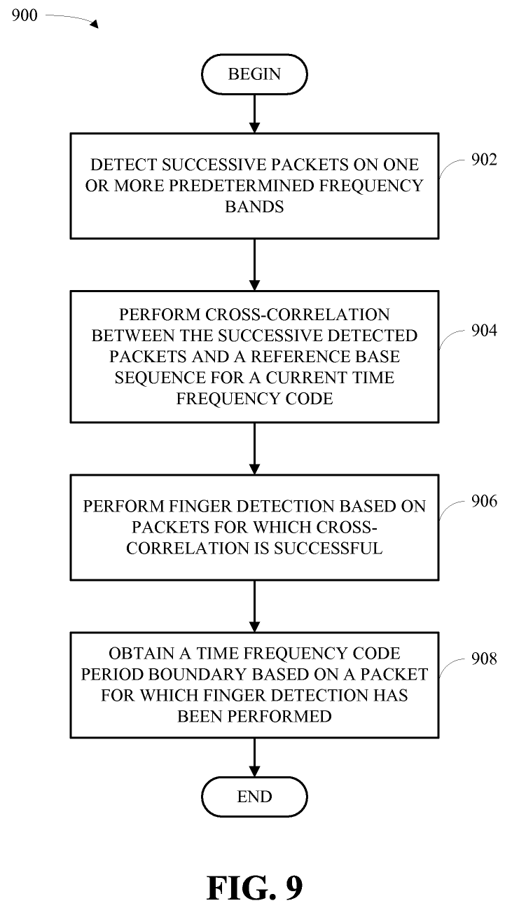

Referring now to FIGS. 9-11, methodologies that may be implemented in accordance with various aspects described herein are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies in accordance with the claimed subject matter.

Furthermore, the claimed subject matter may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Referring to FIG. 9, a method 900 of timing synchronization in a wireless communication system (e.g., system 100) is illustrated. At 902, successive packets are detected (e.g., by a packet detector 244 at a device 200) on one or more predetermined frequency bands. At 904, cross-correlation is performed (e.g., by a cross-correlation component 246) between the successive packets detected at 902 and a reference base sequence for a current time frequency code. At 906, finger detection is performed (e.g., by a finger detector 248) based on packets for which the cross-correlation at 906 is successful. At 908, a time frequency code period boundary is obtained (e.g., by a TFC period locker 250) based on a packet for which finger detection has been performed at 906.

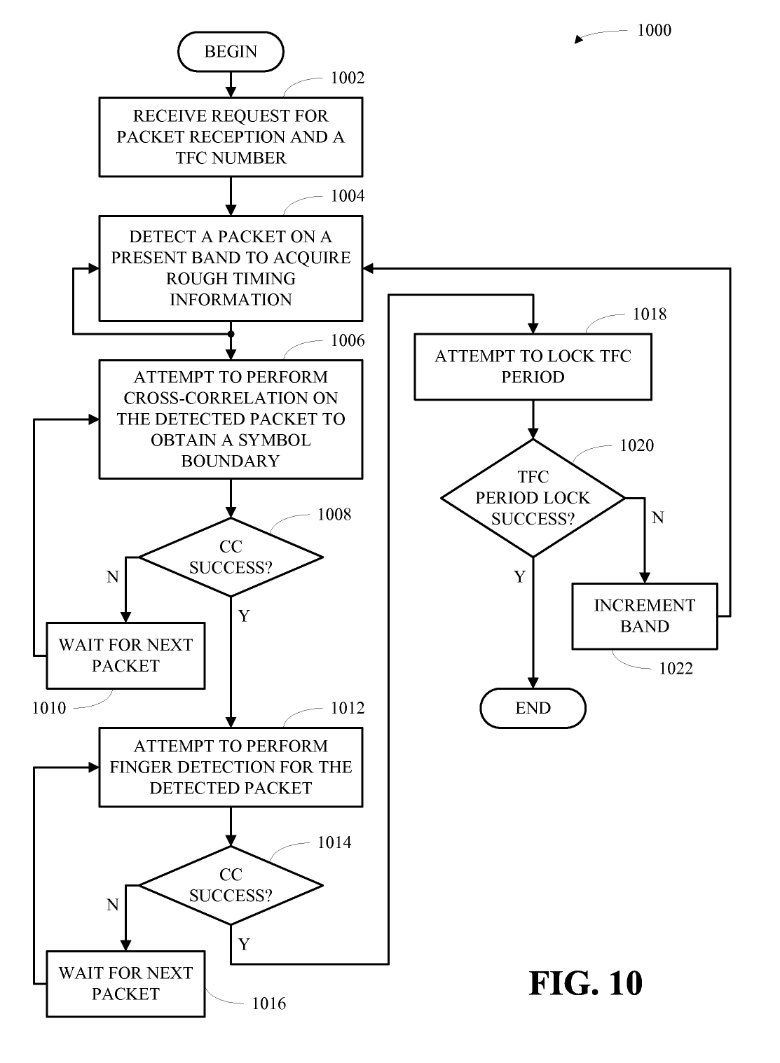

Turning now to FIG. 10, a flowchart of a method 1000 of timing synchronization in a wireless communication system is provided. At 1002, a request for packet reception and a desired TFC number is received (e.g., by a timing synchronization controller 242 from a MAC-PHY interface 220 at a device 220). At 1004, a packet is detected on a present band in order to acquire rough timing information for the wireless communication system. Upon detecting a packet at 1004, 1004 can be re-executed to detect successive packets for the following acts in method 1000. In addition, method 1000 can proceed to 1006, where cross-correlation is attempted on a packet detected at 1004 to obtain a symbol boundary from the packet.

At 1008, it is then determined whether the cross-correlation at 1006 has successfully completed for the packet. If cross-correlation fails at 1006, method proceeds to 1010 to wait for a subsequent packet to be detected at 1004. Once a subsequent packet is detected, 1006 can then repeat for the subsequent packet. On the other hand, if the cross-correlation at 1006 successfully completes for a packet, method 1000 can proceed to 1012, where finger detection is attempted for the packet. At 1014, it is determined whether the finger detection at 1012 has successfully completed. If finger detection fails at 1012, method proceeds to 1016 to wait for a subsequent packet to be successfully cross-correlated at 1006 such that the finger detection at 1012 can be repeated for the subsequent packet.

Otherwise, if the finger detection at 1012 successfully completes for a packet, method 1000 can proceed to 1018, wherein an attempt is made to lock into the period of the TFC corresponding to the TFC number received at 1002. At 1020, it is determined whether the TFC locking at 1018 has completed successfully. If the TFC period locking is successful at 1018, method 1000 can conclude following the determination at 1020. If the TFC period locking at 1018 fails, however, method 1000 can instead proceed to 1022, where the band used for method 1000 is incremented, and return to 1004 to continue packet detection.

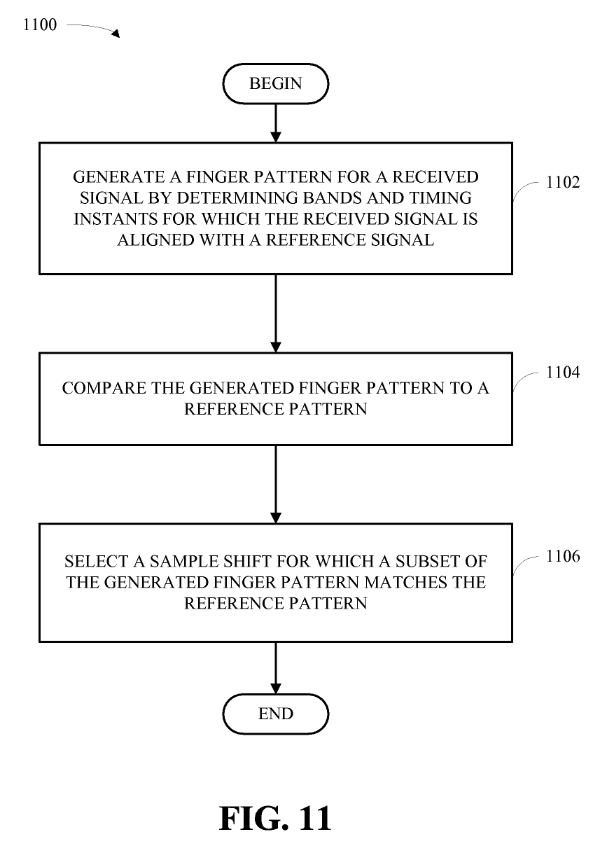

FIG. 11 illustrates a method 1100 of identifying a time frequency code based on finger detection in accordance with various aspects. At 1102, a finger pattern (e.g., a finger pattern 812) is generated (e.g., by a finger pattern generator 810 at a finger detector 800) for a received signal by determining bands and timing instant for which the received signal is aligned with a reference signal. At 1104, the finger pattern generated at 1102 is compared (e.g., by a matching component 830) to a reference pattern (e.g., a reference pattern 820). At 1106, a sample shift is selected for which a subset of the finger pattern generated at 1102 matches the reference pattern.

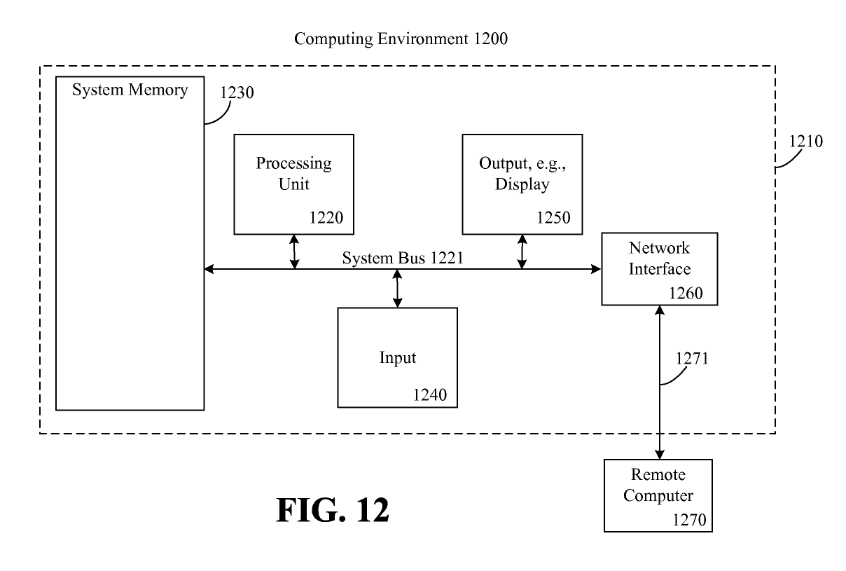

Turning to FIG. 12, an exemplary non-limiting computing system or operating environment in which various aspects described herein may be implemented is illustrated. One of ordinary skill in the art can appreciate that handheld, portable and other computing devices and computing objects of all kinds are contemplated for use in connection with the claimed subject matter, i.e., anywhere that a communications system may be desirably configured. Accordingly, the below general purpose remote computer described below in FIG. 12 is but one example of a computing system in which the claimed subject matter may be implemented.

Although not required, the claimed subject matter can partly be implemented via an operating system, for use by a developer of services for a device or object, and/or included within application software that operates in connection with one or more components of the claimed subject matter. Software may be described in the general context of computer-executable instructions, such as program modules, being executed by one or more computers, such as client workstations, servers or other devices. Those skilled in the art will appreciate that the claimed subject matter can also be practiced with other computer system configurations and protocols.

FIG. 12 thus illustrates an example of a suitable computing system environment 1200 in which the claimed subject matter may be implemented, although as made clear above, the computing system environment 1200 is only one example of a suitable computing environment for a media device and is not intended to suggest any limitation as to the scope of use or functionality of the claimed subject matter. Further, the computing environment 1200 is not intended to suggest any dependency or requirement relating to the claimed subject matter and any one or combination of components illustrated in the example operating environment 1200.

With reference to FIG. 12, an example of a remote device for implementing various aspects described herein includes a general purpose computing device in the form of a computer 1210. Components of computer 1210 can include, but are not limited to, a processing unit 1220, a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures.

Computer 1210 can include a variety of computer readable media. Computer readable media can be any available media that can be accessed by computer 1210. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a modulated data signal such as a carrier wave or other transport mechanism and can include any suitable information delivery media.

The system memory 1230 can include computer storage media in the form of volatile and/or nonvolatile memory such as read only memory (ROM) and/or random access memory (RAM). A basic input/output system (BIOS), containing the basic routines that help to transfer information between elements within computer 1210, such as during start-up, can be stored in memory 1230. Memory 1230 can also contain data and/or program modules that are immediately accessible to and/or presently being operated on by processing unit 1220. By way of non-limiting example, memory 1230 can also include an operating system, application programs, other program modules, and program data.

The computer 1210 can also include other removable/non-removable, volatile/nonvolatile computer storage media. For example, computer 1210 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 1221 through a non-removable memory interface such as an interface, and a magnetic disk drive or optical disk drive can be connected to the system bus 1221 by a removable memory interface, such as an interface.

A user can enter commands and information into the computer 1210 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 1220 through user input 1240 and associated interface(s) that are coupled to the system bus 1221, but can be connected by other interface and bus structures, such as a parallel port, game port or a universal serial bus (USB). A graphics subsystem can also be connected to the system bus 1221. In addition, a monitor or other type of display device can be connected to the system bus 1221 via an interface, such as output interface 1250, which can in turn communicate with video memory. In addition to a monitor, computers can also include other peripheral output devices, such as speakers and/or a printer, which can also be connected through output interface 1250.

The computer 1210 can operate in a networked or distributed environment using logical connections to one or more other remote computers, such as remote computer 1270, which can in turn have media capabilities different from device 1210. The remote computer 1270 can be a personal computer, a server, a router, a network PC, a peer device or other common network node, and/or any other remote media consumption or transmission device, and can include any or all of the elements described above relative to the computer 1210. The logical connections depicted in FIG. 12 include a network 1271, such local area network (LAN) or a wide area network (WAN), but can also include other networks/buses. Such networking environments are commonplace in homes, offices, enterprise-wide computer networks, intranets and the Internet.

When used in a LAN networking environment, the computer 1210 is connected to the LAN 1271 through a network interface or adapter. When used in a WAN networking environment, the computer 1210 can include a communications component, such as a modem, or other means for establishing communications over the WAN, such as the Internet. A communications component, such as a modem, which can be internal or external, can be connected to the system bus 1221 via the user input interface at input 1240 and/or other appropriate mechanism. In a networked environment, program modules depicted relative to the computer 1210, or portions thereof, can be stored in a remote memory storage device. It should be appreciated that the network connections shown and described are exemplary and other means of establishing a communications link between the computers can be used.

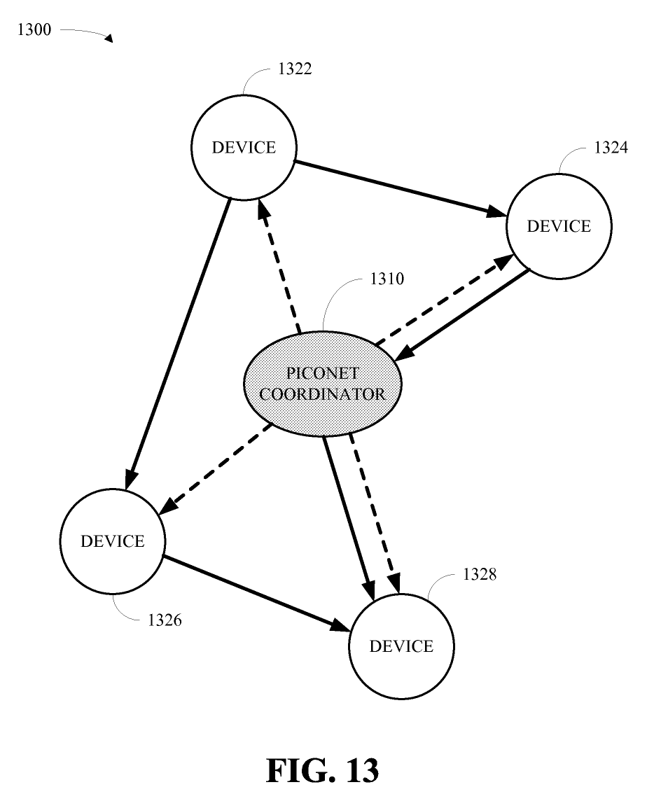

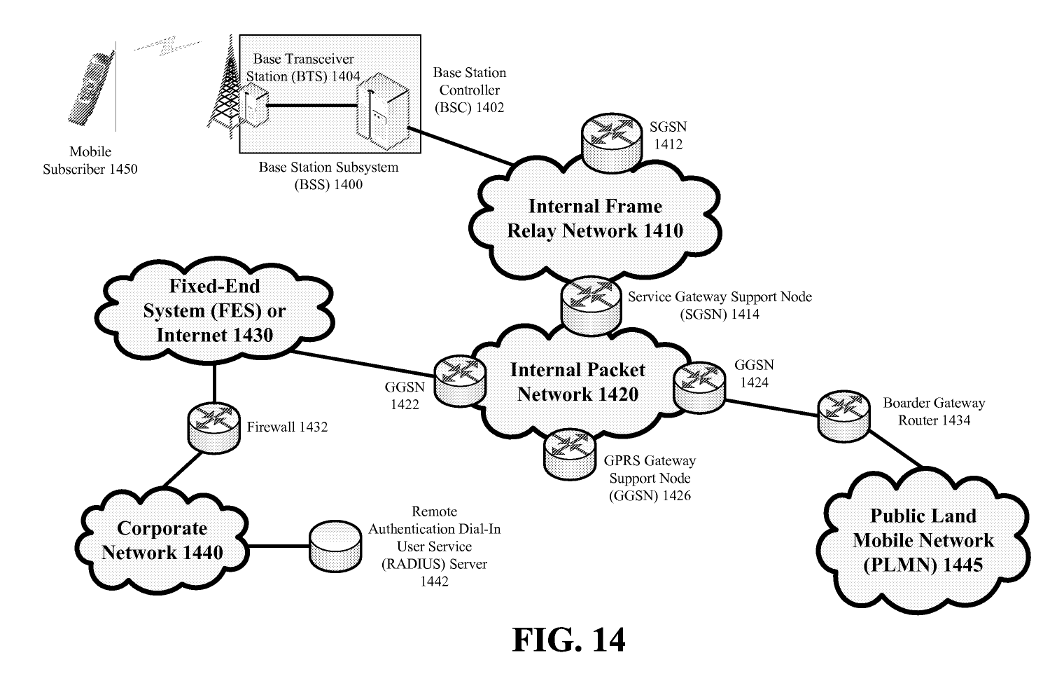

Turning now to FIGS. 13-14, an overview of network environments in which the claimed subject matter can be implemented is illustrated. The above-described systems and methodologies for timing synchronization may be applied to any wireless communication network; however, the following description sets forth some exemplary, non-limiting operating environments for said systems and methodologies. The below-described operating environments should be considered non-exhaustive, and thus the below-described network architectures are merely examples of network architectures into which the claimed subject matter can be incorporated. It is to be appreciated that the claimed subject matter can be incorporated into any now existing or future alternative architectures for communication networks as well.

Referring first to FIG. 13, a wireless personal area network (WPAN) architecture 1300 is illustrated based on the IEEE 802.15.3 high data rate WPAN standard. Based on the IEEE 802.15.3 standard, the WPAN architecture 1300 can include one or more piconets. As used herein, a piconet is an ad hoc network of independent data devices 1310-1328 that can engage in peer-to-peer communication. FIG. 13 illustrates one such piconet. In one example, the range of a piconet is confined to a personal area of, for example, 10 to 50 meters, although a piconet can alternatively provide coverage for a larger or smaller coverage area.

In accordance with one aspect, a piconet can be established by a device 1310 that is capable of becoming a piconet coordinator (PNC). The device 1310 can establish the piconet by scanning a set of available communication channels (e.g., communication channels corresponding to time frequency codes in an MB-OFDM communication environment) for a channel having a least amount of interference that is not in use by neighboring piconets. Once such a communication channel is found, the device 1310 can become a PNC and begin transmitting control messaging in the form of beacons to allow other devices 1322-1328 to connect to the piconet. As illustrated in architecture 1300, beacons transmitted by PNC 1310 are shown by dotted lines.

Once a PNC 1310 establishes a piconet, one or more devices 1322-1328 can associate with the PNC 1310 based on beacons transmitted by the PNC 1310. In one example, beacons provided by a PNC 1310 can provide timing information, and a device 1322-1328 can perform one or more timing synchronization techniques based on received beacons as described supra while associating with the piconet coordinated by the PNC 1310. In addition, beacons transmitted by the PNC 1310 can also contain information relating to quality of service (QoS) parameters, time slots for transmission by devices 1322-1328 in the piconet, and/or other suitable information. After a device 1322-1328 has successfully associated with the piconet, it can then communicate in the piconet by transmitting data to the PNC 1310 and/or one or more other devices 1322-1328 in the piconet. As illustrated in architecture 1300, data transmissions are indicated by solid lines.

In accordance with one aspect, the PNC 1310 and devices 1322-1328 can additionally communicate using ultra-wideband (UWB) communication. When UWB is used, the PNC 1310 and/or devices 1322-1328 can communicate beacons and/or data using short-duration pulses that span a wide range of frequencies. In one example, transmissions made pursuant to UWB can occupy a spectrum of greater than 20% of a center frequency utilized by the network or a bandwidth of at least 500 MHz. Accordingly, UWB transmissions can be conducted using a very low power level (e.g., approximately 0.2 mW), which can allow UWB transmission to be conducted in common bands with other forms of communication without introducing significant interference levels. Because UWB operates at a low power level, it should be appreciated that UWB is typically confined to a small coverage area (e.g., approximately 10 to 100 meters), which can correspond to the coverage area of an associated piconet. However, by transmitting in short radio bursts that span a large frequency range, devices utilizing UWB can transmit significantly large amounts of data without requiring a large amount of transmit power. Further, because of the large bandwidth range and low transmit power used in UWB transmission, signals transmitted utilizing UWB can carry through obstacles that can reflect signals at lower bandwidth or higher power.

Turning now to FIG. 14, various aspects of the global system for mobile communication (GSM) are illustrated. GSM is one of the most widely utilized wireless access systems in today's fast growing communications systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1×Evolution Data Optimized (“EVDO”), Code Division Multiple Access-2000 (“cdma2000 3×”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the timing synchronization techniques described herein may be applied independently of the method of data transport, and does not depend on any particular network architecture or underlying protocols.

FIG. 14 depicts an overall block diagram of an exemplary packet-based mobile cellular network environment, such as a GPRS network, in which the claimed subject matter can be practiced. Such an environment can include a plurality of Base Station Subsystems (BSS) 1400 (only one is shown), each of which can comprise a Base Station Controller (BSC) 1402 serving one or more Base Transceiver Stations (BTS) such as BTS 1404. BTS 1404 can serve as an access point where mobile subscriber devices 1450 become connected to the wireless network. In establishing a connection between a mobile subscriber device 1450 and a BTS 1404, one or more timing synchronization techniques as described supra can be utilized.

In one example, packet traffic originating from mobile subscriber 1450 is transported over the air interface to a BTS 1404, and from the BTS 1404 to the BSC 1402. Base station subsystems, such as BSS 1400, are a part of internal frame relay network 1410 that can include Service GPRS Support Nodes (“SGSN”) such as SGSN 1412 and 1414. Each SGSN is in turn connected to an internal packet network 1420 through which a SGSN 1412, 1414, etc., can route data packets to and from a plurality of gateway GPRS support nodes (GGSN) 1422, 1424, 1426, etc. As illustrated, SGSN 1414 and GGSNs 1422, 1424, and 1426 are part of internal packet network 1420. Gateway GPRS serving nodes 1422, 1424 and 1426 can provide an interface to external Internet Protocol (“IP”) networks such as Public Land Mobile Network (“PLMN”) 1445, corporate intranets 1440, or Fixed-End System (“FES”) or the public Internet 1430. As illustrated, subscriber corporate network 1440 can be connected to GGSN 1422 via firewall 1432; and PLMN 1445 can be connected to GGSN 1424 via boarder gateway router 1434. The Remote Authentication Dial-In User Service (“RADIUS”) server 1442 may also be used for caller authentication when a user of a mobile subscriber device 1450 calls corporate network 1440.

Generally, there can be four different cell sizes in a GSM network—macro, micro, pico, and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The claimed subject matter has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

What is claimed is:

1. A system for timing synchronization in a wireless communication system, comprising:
a first data device and a second data device, the first data device establishes a connection for communication in the wireless communication system based on one or more packets received from the second data device; and
a timing synchronization component associated with the first data device that receives successive packets of data and processes the successive packets to identify timing information relating to a time frequency code (TFC) that is utilized for communication in the wireless communication system.

2. The system of claim 1, wherein the timing synchronization component comprises a state machine that transitions between an idle state, an initialized state, a sample-locked state, and a success state.

3. The system of claim 2, wherein the state machine is initialized at the idle state, transitions from the idle state to the initialized state when the first data device detects a packet from the second data device, transitions from the initialized state to the sample-locked state when a sample boundary corresponding to the detected packet is locked by the first data device, and transitions from the sample-locked state to the success state when a time frequency code period boundary corresponding to the detected packet is locked by the first data device.

4. The system of claim 2, wherein the state machine transitions from the initialized state to the idle state if the first data device fails to detect a packet within a predetermined period of time, transitions from the sample-locked state to the idle state if the first data device fails to lock a time frequency code period boundary corresponding to a detected packet within a predetermined length of time, and transitions from the success state to the idle state if the first data device is reset.

5. The system of claim 1, wherein the timing synchronization component comprises:
a packet detector that attempts to detect successive packets transmitted by the second data device;
a cross-correlation component that correlates successive detected packets with a reference base sequence corresponding to a predetermined time frequency code;
a finger detector that utilizes one or more frequency band finger detection algorithms to identify a sample boundary corresponding to the predetermined time frequency code in successive cross-correlated packets; and
a time frequency code period detector that obtains a time frequency code period boundary based on a packet processed by the finger detector and locks the first data device into the obtained period boundary.

6. The system of claim 5, wherein the first data device further comprises a MAC-PHY interface that provides an identity of the predetermined time frequency code to the timing synchronization component and the timing synchronization component further comprises a timing synchronization controller that initializes timing synchronization at the first data device upon receiving the identity of the predetermined time frequency code.

7. The system of claim 5, wherein the finger detector comprises:
a finger pattern generator that generates a finger pattern for a cross-correlated packet at least in part by determining respective frequencies and timing instants in the cross-correlated packet for which the cross correlation performed by the cross-correlation component results in a value greater than a predetermined threshold; and
a matching component that obtains a time frequency code sample boundary corresponding to the cross-correlated packet by comparing the generated finger pattern to a reference pattern.

8. The system of claim 7, wherein the reference pattern is a Reference Frequency Band Finger Pattern (R-FBFP) that represents a band-hopping sequence of the predetermined time frequency code.

9. The system of claim 7, wherein the reference pattern is a Reduced Reference Frequency Band Finger Pattern (RR-FBFP) that represents a subset of a band-hopping sequence of the predetermined time frequency code and the matching component compares the generated finger pattern to the represented subset of the band-hopping sequence in the RR-FBFP.

10. A wireless personal area network (WPAN) piconet employing the system of claim 1, wherein the second data device is a piconet coordinator.

11. A Multi-Band OFDM communication environment employing the system of claim 1, wherein the first data device and the second data device communicate using ultra-wideband communication.

12. A method of timing synchronization for a device in a wireless communication system, comprising:
detecting successive packets on a frequency band determined for use;
performing cross-correlation between the successive detected packets and a reference base sequence;
performing finger detection based on packets for which cross-correlation is successfully performed to determine time frequency code sample boundaries corresponding to the packets for which cross-correlation is successfully performed; and
obtaining a time frequency code period boundary based on a packet for which finger detection has been performed.

13. The method of claim 12, further comprising receiving a request to perform timing synchronization, the request comprising an identity of the frequency band determined for use.

14. The method of claim 14, wherein the performing cross-correlation comprises:
determining whether cross-correlation has failed for a present packet in the successive detected packets;
checking for a subsequent detected packet if cross-correlation for the present packet is determined to have failed; and
if a subsequent detected packet is not present, incrementing the frequency band determined for use and restarting the detecting successive packets.

15. The method of claim 14, wherein the obtaining a time frequency code period boundary comprises:
determining whether a time frequency code period boundary has been obtained within a predetermined amount of time; and
if a time frequency code period boundary has not been obtained within the predetermined amount of time, incrementing the frequency band determined for use and restarting the detecting successive packets.

16. The method of claim 14, wherein the performing finger detection comprises:
generating respective finger patterns based on the packets for which cross-correlation is successfully performed;
comparing the respective finger patterns to a reference pattern; and
obtaining respective time frequency code sample boundaries at least in part by selecting a sample shift for which subsets of the respective finger patterns match the reference pattern.

17. The method of claim 16, further comprising receiving an identity of a predetermined time frequency code, wherein the obtaining respective time frequency code sample boundaries includes selecting a sample shift for which subsets of the respective finger patterns match a portion of the reference pattern corresponding to the predetermined time frequency code.

18. A computer-readable medium having stored thereon instructions operable to perform the method of claim 12.

19. A system that facilitates timing synchronization between devices in a wireless communication system, comprising:
means for detecting successive packets on one or more predetermined frequency bands pursuant to a predetermined time frequency code;
means for obtaining sample boundaries for the predetermined time frequency code based at least in part on successive detected packets; and
means for obtaining a period boundary for the predetermined time frequency code based at least in part on a packet based on which sample boundaries have been obtained.

20. The system of claim 19, wherein the means for obtaining sample boundaries for the predetermined time frequency code comprises:
means for cross-correlating successive detected packets with a reference signal for the predetermined time frequency code to obtain respective cross-correlated values;
means for generating a finger pattern at least in part by identifying cross-correlated values that are above a predetermined threshold;
means for comparing the generated finger pattern to a reference pattern corresponding to the predetermined time frequency code; and
means for identifying sample boundaries at least in part by selecting a sample shift for which a portion of the finger pattern matches the reference pattern.
